(19) United States
(12) Patent Application Publication
(10) Pub. No.: US 2011/0248493 A1
(43) Pub. Date: Oct. 13, 2011

(54) FOLDING MAILER

(76) Inventor: Michael P. Aronstein, Yorktown Heights, NY (US)

(21) Appl. No.: 13/082,309

(22) Filed: Apr. 7, 2011

Related U.S. Application Data
(60) Provisional application No. 61/321,668, filed on Apr. 7, 2010.

(51) Int. Cl. B42D 15/04

(52) U.S. Cl. 283/116

(57) ABSTRACT

Embodiments of the present invention provide a folding mailer that can provide one or more of the following advantages: accommodate pictures or other printed material extending across multiple portions of the item, be folded into a minimal thickness for efficient mailing, be unfolded into a relatively large continuous display surface, and be folded and mailed without external packaging or adhesives that can mar or damage portions of the item when opened.

### CROSS REFERENCE TO RELATED APPLICATIONS

This application claims priority as a continuation of U.S. provisional application 61/321,668, filed Apr. 7, 2010, which application is incorporated herein by reference.

### FIELD OF THE INVENTION

This invention relates to items suitable for mailing, and more specifically to items that can receive a large format image or collage of images, and then be folded for convenient mailing.

### BACKGROUND OF THE INVENTION

Printed items are used to share photos and information, for example in picture postcards, souvenir posters and photographs, etc. Various foldable items have been proposed to allow large format (larger than customary one page postcard) to be mailed within normal mailing size constraints.

As an example, U.S. Pat. No. 3,141,549 discloses a foldable postal card. The disclosed postal card comprise a paper fold construction which provides a flip action with a portion of the fold is pulled out or otherwise moved by finger action. The patent asserts that conventional folding postal cards provide nothing to forcefully call attention to any particular portion of the card. A stated object of the patent is to provide a foldable postal card which provides a flip action so as to call attention to a particular portion of the card in a striking manner. The card opens along parallel fold lines, and has a crease that allows one portion of the card to be pulled out. In some embodiments, a tab engages a slot in the middle of a surface (after folding), covering and inhibiting the action of the flip action mechanism.

As another example, U.S. Pat. No. 3,190,541 discloses a greeting card assembly that fold to provide a slotted compartment for holding a personal letter or the like. The assembly has a slot that allows access to a compartment formed by folding of the card. In some embodiments, flaps are provided which overlap and are glued to the rest of the card to seal the assembly.

As another example, U.S. Pat. No. 4,780,975 discloses a self mailer that provides one or two separate framed pockets, formed of multiple layers of material that combine to provide a pocket for a separate photo with an open viewing area with a surrounding border. The mailer can be folded such that the viewing area(s) are on the outside faces of an easel formed by the mailer. The thickness of the photo frame portions requires that the sheet be cut in multiple display embodiments, as in FIG. 14.

As another example, U.S. patent application 20030222128 discloses a picture postcard mailer with rigid frame and stand. A frame portion defines a viewing aperture and a pocket to retain a picture inserted into the pocket. A portion of the frame portion on a surface opposite the viewing aperture can partially separated from the frame portion and hinged outward to provide support to the frame portion allowing upright display of the picture.

The art, however, cannot accommodate pictures or other printed material extending across multiple portions of the item, and cannot be folded into a minimal thickness for efficient mailing, and cannot be unfolded into a relatively large continuous display surface, and cannot be folded and mailed without external packaging or adhesives that can mar or damage at least portions of the item when opened.

### BRIEF DESCRIPTION OF THE DRAWINGS

The accompanying drawings, which are incorporated in and form part of the specification, illustrate the present invention and, together with the description, describe the invention. In the drawings, like elements are referred to by like numbers. FIG. 1(a,b,c,d,e) comprise illustrations of an example mailer according to the present invention at various stages of folding.

FIG. 2(a,b,c,d,e) comprise illustrations of an example mailer like that in FIG. 1 with images printed thereon.

FIG. 3 is an illustration of an example mailer according to the present invention with curved edges.

FIG. 4 is an illustration of an example embodiment according to the present invention with a variation of folding pattern and tab/slot relationship.

FIG. 5 is an illustration of an example embodiment according to the present invention with an additional fold relative to an embodiment such as in FIG. 1.

FIG. 6 is an illustration of an example embodiment like that in FIG. 5 except with a variation of folding pattern and tab/slot relationship.

FIG. 7 is an illustration of an example embodiment where the item has two nonparallel sides.

FIG. 8(a,b,c,d) is an illustration of an example embodiment according to the present invention, having a roughly pennant shape and showing several stages of folding.

FIG. 9(a,b,c,d,e) is an illustration of an example embodiment according to the present invention, having folds that define several roughly triangular portions and showing several stages of folding.

FIG. 10 is an illustration of an example embodiment according to the present invention having a roughly circular shape foldable along radial lines.

FIG. 11 is an illustration of an example embodiment according to the present invention formed from a single rectangular sheet.

FIG. 12 is an illustration of an example embodiment of the present invention suitable for continuous feed production.

FIG. 13 is an illustration of an example embodiment allowing two triangular mailers to be produced from a single rectangular sheet.

FIG. 14 and FIG. 15 comprise illustrations of an example embodiment illustrating alternative tab configurations.

FIG. 16 is an illustration of an example embodiment illustrating alternative tab configurations.

FIG. 17 comprises illustrations of various alternative tab configurations.

FIG. 18 is a photograph of an example mailer embodiment according to the present invention.

FIG. 19 is a photograph of an example mailer embodiment according to the present invention.

### DETAILED DESCRIPTION OF THE INVENTION

The present invention is described in terms of a mailer, where a “mailer” refers to an item that can be folded or otherwise configured to a shape and size suitable for mailing through postal services or other flat item delivery services. As used herein, “mailer” also includes items that can be folded for more convenient handling, even if the final size, shape, thickness, weight, or material is not suitable for delivery by postal services. Mailers according to the present invention can have images incorporated into them, where an “image” includes any graphical information, including without limitation photographs, drawings, text, collages of photographs, and combinations of the preceding. Images can be incorporated into mailers in various manners known to those skilled in the art, including as examples by various mass production printing methods, individual item printing methods, application by hand (such as handwriting or drawing), and combinations thereof. Mailers are described herein as having prefold lines, where a “prefold line” includes any element that facilitates folding of the sheet along that line, as examples including indications such as dotted lines printed on the sheet, scorings of the sheet, perforations in the sheet, pressed lines into the sheet. Scoring can make folding easy to accomplish reliably on the desired line, and does not generally interfere with an image placed on the sheet. Perforations can make folding easy, and can make the sheet easy to separate along the prefold lines (desirable if the application desires to separate the sheet), but can interfere with an image that crosses the perforation line. Fold indications printed on the sheet can be easy to place, but can lead to inaccurate folding and in some instances can interfere with images that cross such fold indications. Lines pressed into the sheet can function similarly to scoring, but if the sheet is not cut then pressed lines can pose less interference with images that cross the prefold lines, and can avoid weakening the sheet. Sheets can also have other features such as perforations, for example if it is desired to separate multiple images (e.g., if one mailer has several detachable coupons printed on it).

FIG. 1(a,b,c,d,e) comprise illustrations of an example mailer according to the present invention at various stages of folding. In FIG. 1a, a single sheet 11 of material is depicted. The material can be a preprinted sheet, or a material suitable for receiving an image on one or both sides. As examples, paper of various weights, matte or glossy finishes, posterboard, card stock, plastic sheets can all be suitable for use with the present invention. The single sheet 11 is of generally rectangular shape, which includes squares and rectangles of various aspect ratios. A “generally rectangular shape” is also intended to encompass shapes such as in certain of the other embodiments described herein, including those with non-straight sides but where corners can be aligned after folding along lines such as those described in connection with the relevant figures. The generally rectangular shape has a tab 12 extending from one edge, and extending along less than one half of that edge. A slot 13 is cut into the sheet spaced from an edge of the sheet 11 such that the slot 13 will be parallel to the tab 12 and will mate with the tab edge after folding.

The sheet 11 has three prefold lines: a tab prefold line 14 between the tab and the rest of the sheet, a second prefold line 16 parallel to the tab edge and approximately halfway between tab edge and the opposing edge, and a third prefold line 15 perpendicular to the second prefold line 16 and approximately bisecting the second prefold line 16. The various prefold lines can be accomplished in different manners; as an example, the tab prefold line 14 can be perforated (to facilitate folding, and later separation, of the tab), while the second and third prefold lines 15, 16 can be scored or pressed.

In FIG. 1a the sheet is flat and unfolded. One or more images can be placed on one side of the sheet, or one both sides as described later. The sheet can then be folded along prefold line 15. FIG. 1b shows the sheet after folding the lower portion in FIG. 1a up (out of the page) along prefold line 15 to meet the upper portion in FIG. 1a. The slot 13 is obscured by the portion of the sheet folded up. FIG. 1c shows the other side of the same folding: the slot 13 is visible, as is the tab prefold line 14.

The sheet as shown in FIG. 1b can be folded along prefold line 16, with the right portion being folded over to the left (out of the page) to produce the image of FIG. 1d. The slot 13 is now near the tab. 12, and the resulting mailer has a rectangular shape. The tab 12 can then be folded along tab prefold line 14 (obscured in FIG. 1d by the portions of the sheet that have been folded) and tucked into the slot 13, securing the folded mailer against unintended unfolding. The use of a tab and slot closure can reduce or eliminate the need for adhesive fastening. Adhesive fastening can complicate opening, can make reuse difficult, and can interfere with images that might be in the region of adhesive attachment.

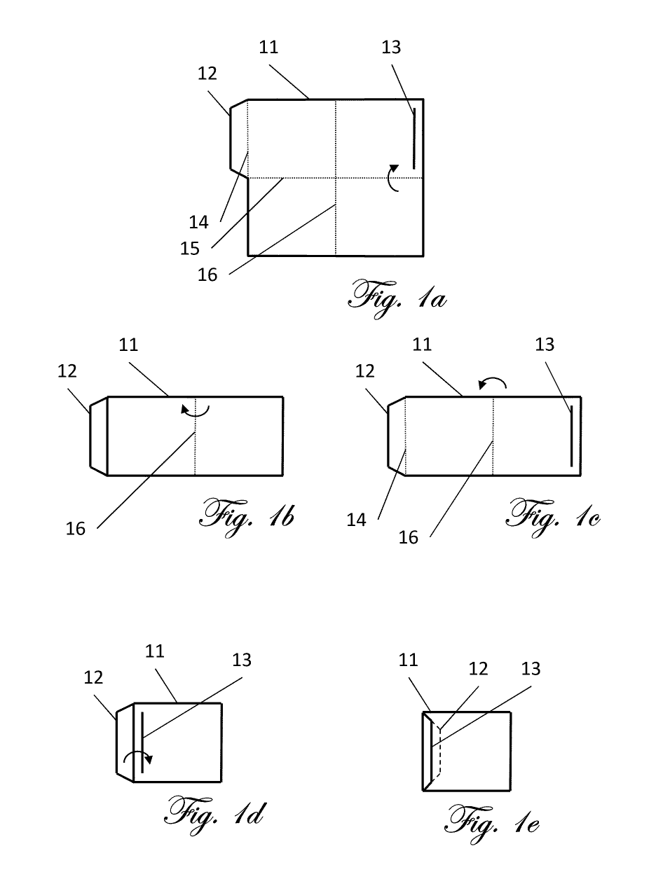

FIG. 2(a,b,c,d,e) comprise an illustration of an example mailer like that in FIG. 1 with images printed thereon. In FIG. 2a, the surface of the sheet 21 that is inside after folding is shown with a photo of a baby. The photo extends over the surface of the sheet, in particular across the prefold lines 25, 26. The sheet has a tab 22 and tab prefold 24 and slot 23, similar to those described in relation to FIG. 1. The opposite side of the sheet 21 is shown in FIG. 2b. This side has different printings on each of the four quadrants formed by prefold lines 25, 26. After a first folding along prefold line 25, the mailer appears as in FIG. 2c. An image of a mother and child and an image of a wrapped present are visible on the quadrants that will be inside after the next fold. An announcement text is visible on one quadrant that will be visible after the next folding. Address and postage can be placed on the fourth quadrant, also visible after the last folding, as in FIG. 2d. Each side of the mailer that is visible after folding and after insertion of the tab into the slot is shown in FIG. 2e.

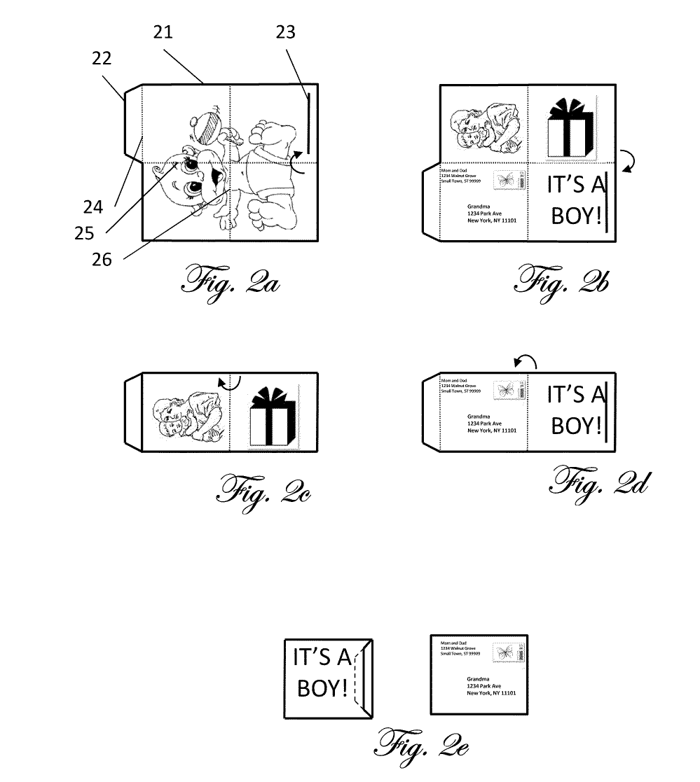

FIG. 3 is an illustration of another example embodiment. The sheet 31 has curved edges at the top and bottom and a tab 32. The opposing corners line up when folded along prefold lines 35, 36. The shape shown in FIG. 3 is intended to fit within the scope of “generally rectangular” as described above. The surface of the sheet shown has several photos; as an example these can be sports photos and the overall mailer be used as memorabilia of a sports team, player, season, or event such as a championship.

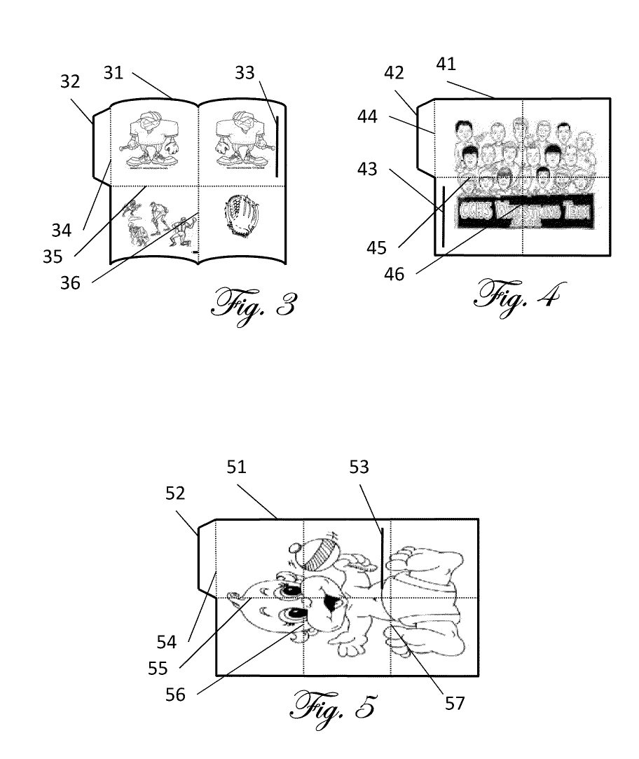

FIG. 4 is an illustration of another example embodiment. The sheet 41 has a generally rectangular shape, with a tab 42. Slot 43 is along the same edge as tab 42. In use, the mailer would first be folded along prefold line 46, and then along prefold line 45, such that when fully folded slot 43 allows engagement of tab 42. As an example of the embodiment in use, the sheet in FIG. 4 has an image of a group, such as a family gathering, a sports team, or a business staff.

FIG. 5 is an illustration of another example embodiment. The sheet 51 has a generally rectangular shape, with a tab 52. A fourth prefold line 57 is roughly parallel to prefold line 56, and together prefold lines 56, 57 divide the sheet into thirds. In use, the sheet 51 is first folded along prefold line 55, then along prefold line 57, then along prefold line 56, leaving slot 53 positioned to engage tab 52. A single image can extend across the prefold lines, as shown in the figure, or multiple images can be placed on the sheet 51.

FIG. 6 is an illustration of another example embodiment. The sheet 61 has a generally rectangular shape, with a tab 62 and prefold lines 64, 65, 66, 67. In use, the sheet 61 is first folded along prefold line 67, then along prefold line 66, then along prefold line 65, leaving slot 63 positioned to engage tab 62.

Additional prefold lines can be employed to allow even larger sheets to be folded into the desired size, for example to comply with mailing limits. Each fold, though, increases the thickness of the folded mailer, so too many folds can lead to excessive mailer thickness.

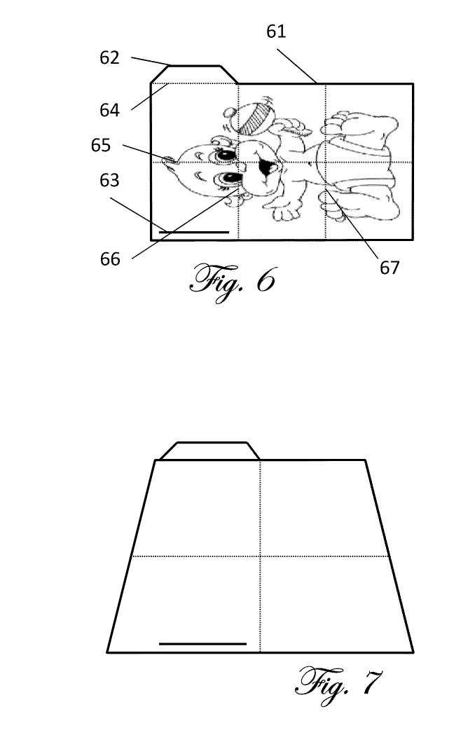

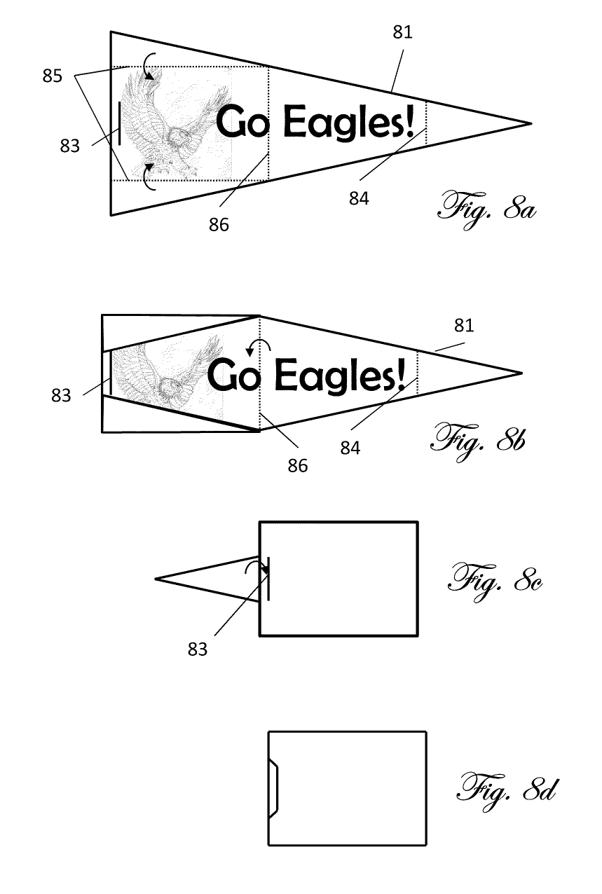

FIG. 7 is an illustration of another example embodiment. A sheet has a trapezoidal shape, with prefold lines roughly bisecting the sides. After folding along the prefold lines, a slot is positioned to engage a tab. The fully folded mailer in this example is not rectangular, which can add interest but can also complicate some mailing operations or require additional postage.

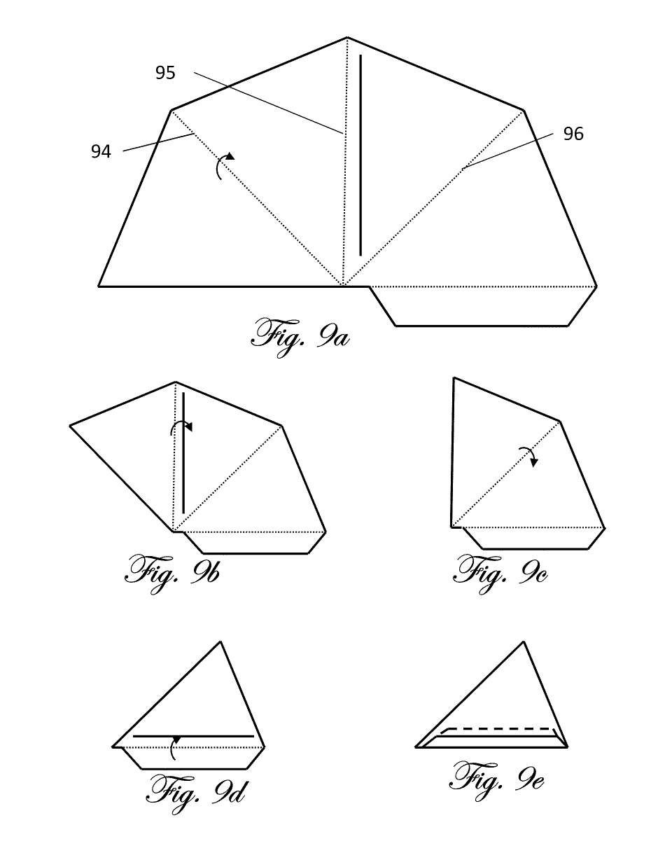

FIG. 8(a,b,c,d) is an illustration of another example embodiment. A sheet 81 has a roughly triangular shape, such as a common pennant. The sheet has a slot 83, and prefold lines 84, 85, and 86. In use, the sheet in FIG. 8a is folded along prefold lines 85 to produce the mailer shown in FIG. 8b. The sheet is then folded along prefold line 86 to produce the mailer shown in FIG. 8c (turned over from the illustration in FIG. 8b). The point of the triangle is then folded along prefold line 84 and tucked into slot 83, producing a rectangular mailer as shown in FIG. 8d.

FIG. 9(a,b,c,d,e) is an illustration of another example embodiment. A sheet is roughly semicircular (with outer straight chords, as shown, or could be with outer edge curved as with a true semicircle). In use, the sheet is first folded along prefold line 94, producing the view as in FIG. 9b. Then it is folded along prefold line 95, producing the view as in FIG. 9c. Then it is folded along prefold line 96, producing the view as in FIG. 9d. Then then tab is folded and inserted in the slot, producing the folded mailer as in FIG. 9e.

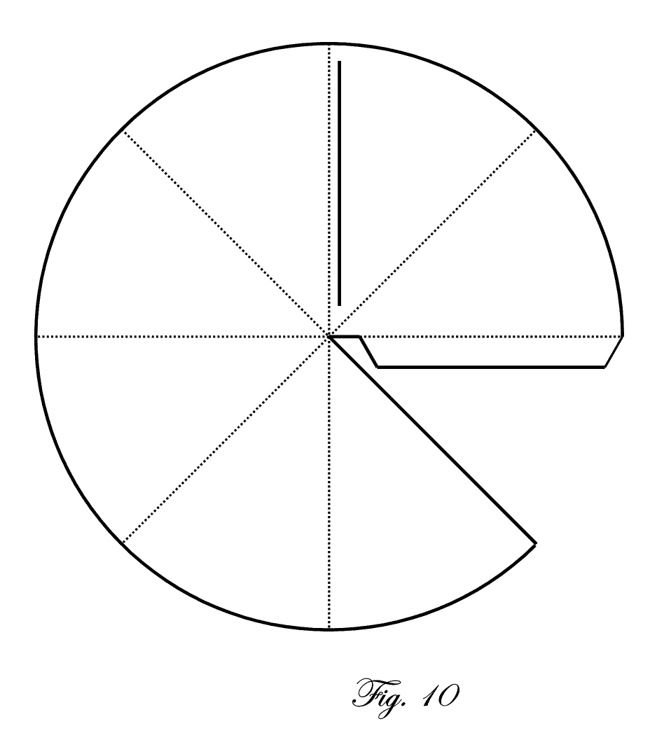

FIG. 10 is an illustration of another example embodiment. A sheet is roughly circular (with outer edge curved, as shown, or could be with outer edge comprised of straight chords), and separated into segments by a plurality of prefold lines. One segment is removed to provide room for a tab. In use, the sheet if successively folded along prefold lines in a similar manner as the example of FIG. 9. After the last fold, the tab is folded and engaged with the slot to yield a finished mailer. Those skilled in the art appreciate that other variations of the shapes described herein are possible and within the scope of the present invention.

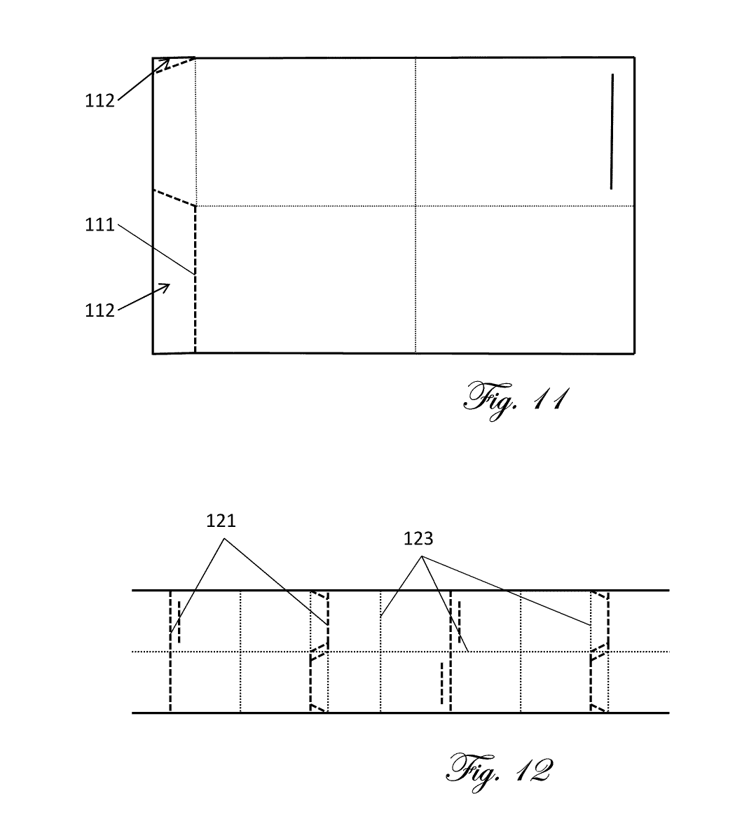

FIG. 11 is an illustration of another example embodiment. A rectangular sheet has perforations or cut guides that allow easy separation of the waste portions 112 from the rest of the sheet, producing a mailer sheet similar to that described in FIG. 1. The waste portions can be removed after printing in a standard printer, allowing the completely rectangular sheet to be printed in accord with many conventional printer configurations that assume rectangular sheets. Similar perforations or cut guides can be used to produce sheets such as those in the other figures, as well.

FIG. 12 is an illustration of an example embodiment suitable for continuous feed production. A continuous sheet has prefold lines 123 placed thereon. The sheet has perforations, cut guides, or is die cut post printing along cut lines 121, to form the desired slot as well as to separate the continuous sheet into separate mailers. The overlapping tabs provide for relatively small waste.

FIG. 13 is an illustration of an example embodiment allowing two triangular mailers to be produced from a single rectangular sheet. The rectangular sheet can be separated along a diagonal of the rectangle. Each triangular half can then be folded along prefold lines shown, and the tip of the triangle inserted into a slot to secure the folded mailer. The tip can be tapered slightly as shown in the lower triangle to better fit the slot. The prefold lines can be at a non-perpendicular angle (exaggerated in the upper triangle in the figure) to result in the tip engaging the slot at a small distance from the edge.

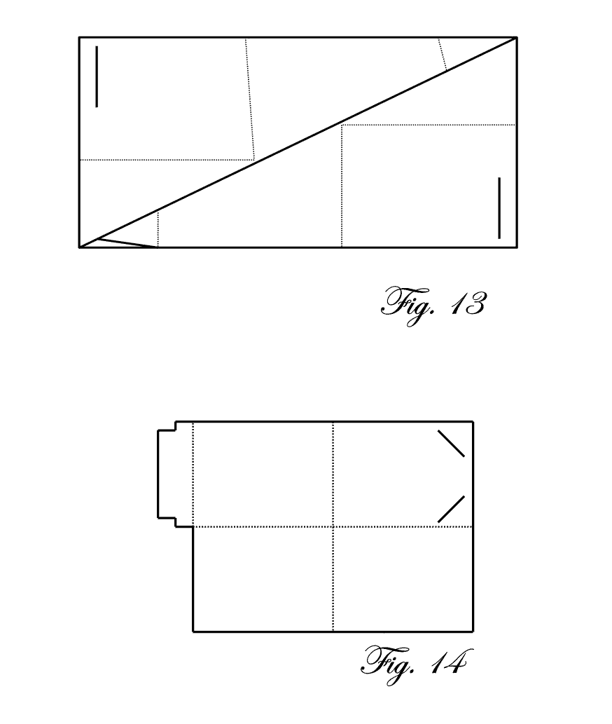

FIG. 14 and FIG. 15 comprise illustrations of an example embodiment illustrating alternate tab configurations. Slots are placed at an angle to the edges of a sheet. A tab has a rectangular shape with relieved edges for at least a part of the length of the tab (as in FIG. 14) or the full length of the tab (as in FIG. 15). After folding, the corners of the tab can be inserted into the angled slots, securing the folded mailer.

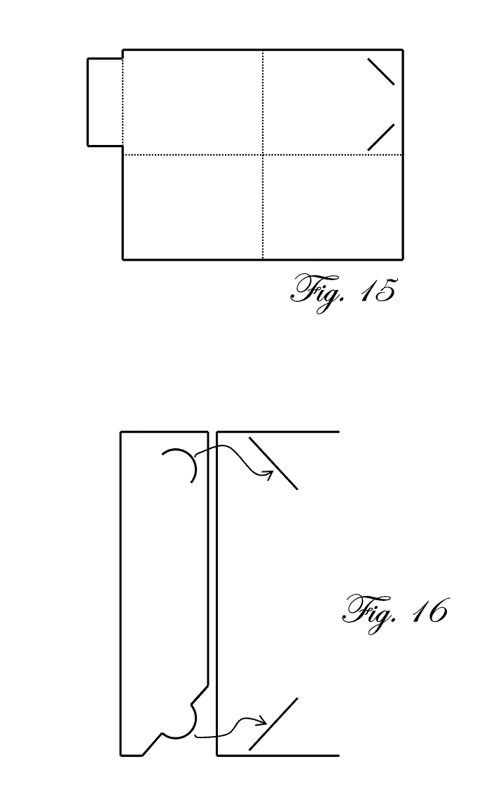

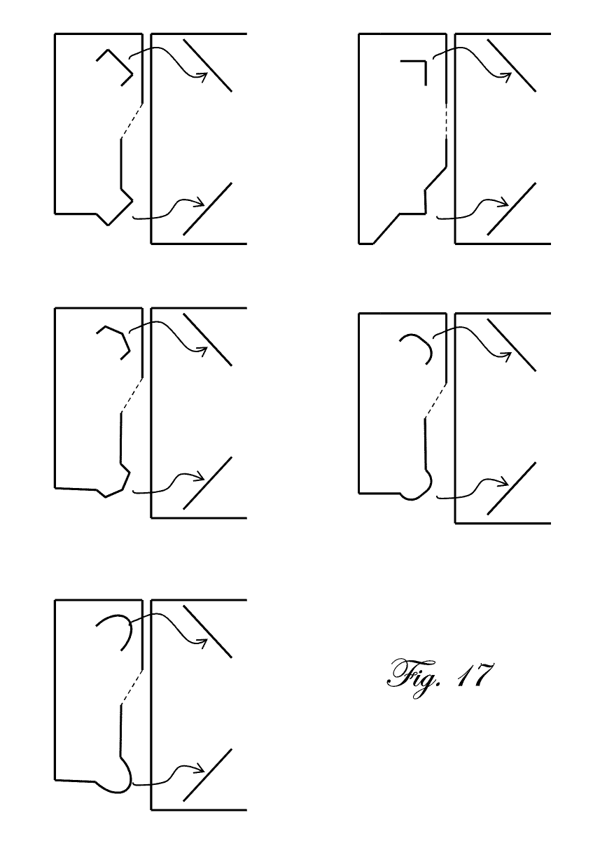

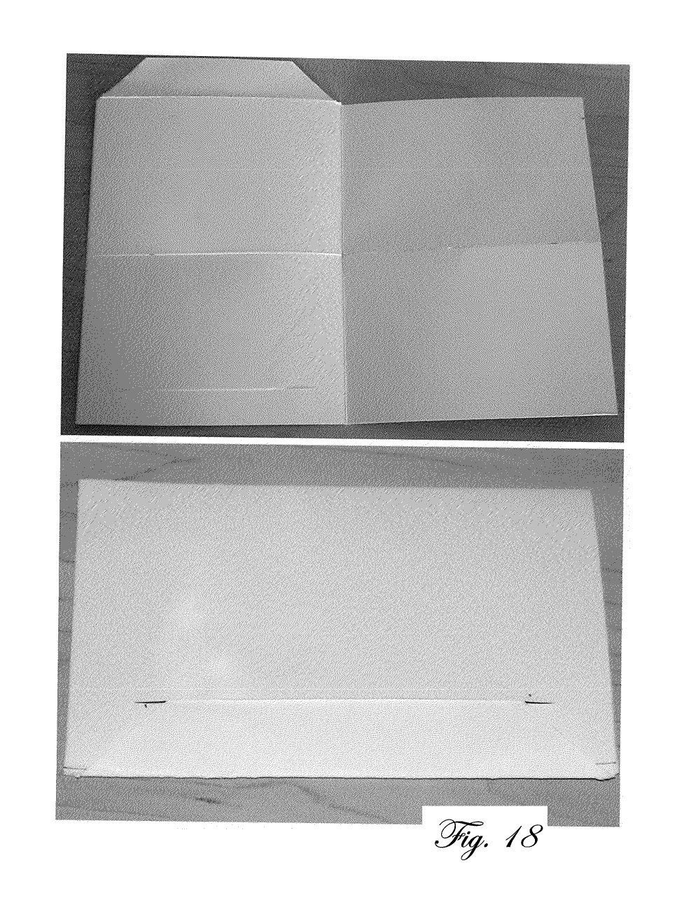

FIG. 16 is an illustration of an example embodiment illustrating an alternative tab configuration. Tabs comprising a semicircular or other convex shape are formed in a portion of a sheet. The tabs can be protrusions from the sheet as shown in the lower tab, or can be cut so as to remain attached to the sheet at a base with a convex portion hinging away from the sheet. The tabs then can engage corresponding slots in another portion of the sheet. FIG. 17 comprises illustrations of alternative tab configurations, with each drawing showing two variations of a selected tab feature shape. Tab features with rounded corners can reduce snagging on automated handling equipment. Tab features that comprise slots cut into a sheet, without changing an overall rectangular shape of the sheet, can facilitate handling by conventional sheet handling equipment.

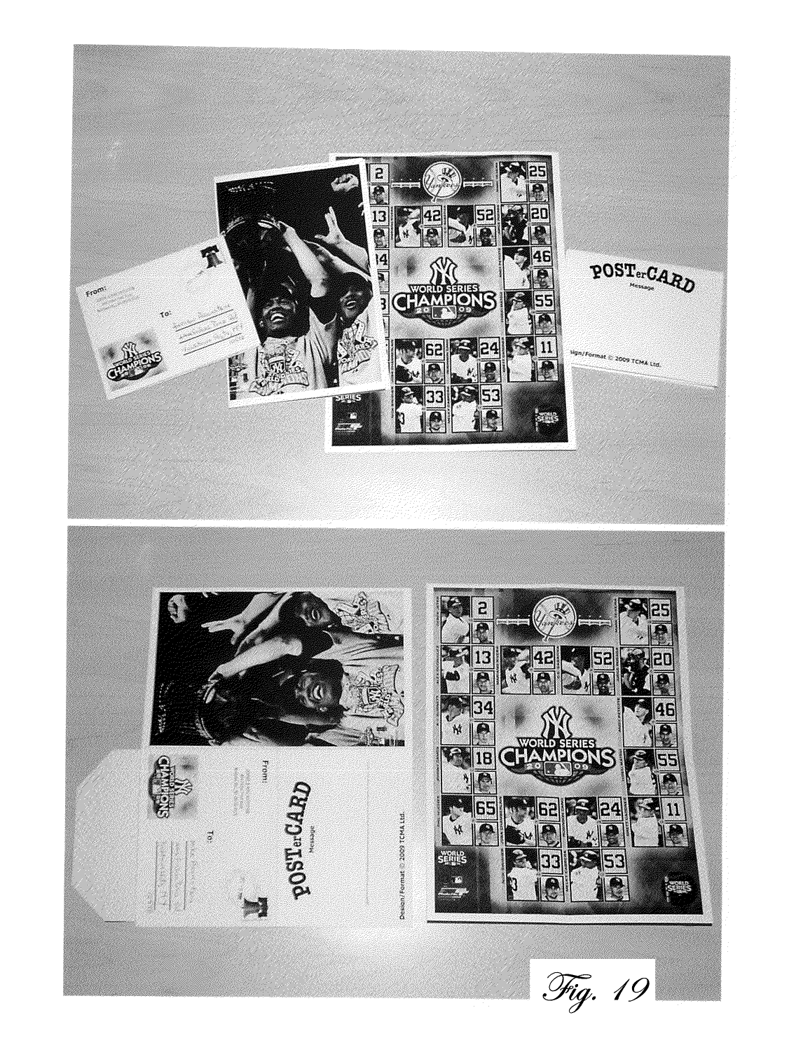

FIG. 18 is a photograph of an example mailer embodiment according to the present invention. The sheet is similar in configuration to that illustrated in FIG. 1, with the photograph showing prefold lines, tab, and slot in an unfolded configuration (top) and after folding and tab insertion (bottom).

FIG. 19 is a photograph of an example mailer embodiment according to the present invention. The sheet is similar in configuration to that illustrated in FIG. 1, with the photograph showing prefold lines, tab, and slot in various stages of folding. In the top portion of the figure, from left: address portion of mailer completely folded and ready to mail; mailer after one folding, showing half-page image that will be concealed after second folding; mailer unfolded, showing full-page image that will be concealed within the folded mailer; back side of mailer after complete folding. In the bottom portion of the figure, from left to right: unfolded mailer, showing address portion, back side, and half-page image; mailer after unfolding and after removal of the tab, showing full-page image suitable for display.

The present invention has been described in view of various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. A mailer comprising a single sheet of printable material having a generally rectangular shape plus a tab extending from a first edge of the rectangle along not more than one half of the first edge;
a. wherein the sheet has a first prefold line substantially parallel to and substantially equidistant from the first edge and a second edge opposite and parallel to the first edge;
b. wherein the sheet has a second prefold line substantially perpendicular and bisecting the first and second edges; and
c. wherein the sheet has a slot in the sheet near the second edge, wherein the slot is configured to accept at least a portion of the tab when the sheet is folded along the first prefold line.

2. A mailer as in claim 1, wherein the edges of the rectangle are straight.

3. A mailer as in claim 1, wherein at least one edge of the rectangle comprises an undulating pattern.

4. A mailer as in claim 1, wherein the sheet has a third prefold line extending along a line where the first edge of the rectangle would lie if the tab were not present.

5. A mailer as in claim 1, wherein the tab extends from the first edge a distance less than one sixteenth the distance between the first and second edges, and wherein the slot is spaced from the second edge less than one thirty second of the distance between the first and second edges.

6. A mailer as in claim 1, wherein the tab extends from the first edge a distance less than one eighth the distance between the first and second edges, and wherein the slot is spaced from the second edge less than one sixteenth of the distance between the first and second edges.

7. A mailer as in claim 1, wherein the first and second prefold lines separate the sheet into four quadrants; wherein a first surface of the sheet is not viewable from the outside when the sheet is folded along the first and second prefold lines, and wherein the first surface has printed thereon an image that extends onto each of the four quadrants.

8. A mailer as in claim 1, wherein the first and second prefold lines separate the sheet into four quadrants; wherein a first quadrant of a second surface of the sheet is viewable from the outside when the sheet is folded along the first and second prefold lines, and wherein the first quadrant of the first surface has printed thereon markings that facilitate writing of a destination address, a sending address, or both.

9. A mailer as in claim 24, comprising a single sheet having a tab extending from one edge of the sheet, and having a plurality of prefold lines, at least two of which are not mutually parallel, and having a slot, such that when the sheet is folded along the prefold lines a portion of the tab engages the slot to discourage unfolding.

10. A mailer as in claim 9 wherein a first surface of the sheet is not viewable from the outside when the mailer is folded along the prefold lines, and wherein one or more images are printed on the first surface such that at least one of the images extends across at least one of the prefold lines.

11. A mailer as in claim 9, wherein the plurality of prefold lines comprises first and second mutually perpendicular prefold lines.

12. A mailer as in claim 11, wherein the plurality of prefold lines comprises a third prefold line substantially parallel to the first prefold line.

13. A mailer as in claim 4, wherein the sheet is scored or perforated along the third prefold line such that removal of the tab is facilitated.

14. A mailer as in claim 9, wherein the sheet is scored or perforated along a line defining the tab separate from the remainder of the sheet such that removal of the tab is facilitated.

15. A mailer having a triangular shape, and having a slot parallel to and spaced apart from a first side of the triangle, and having at least one prefold line parallel to the first side, and having a tab prefold line parallel to the first side, wherein the distance from the first side to the first prefold line not greater than the distance from the first prefold line to the tab prefold line.

16. A mailer as in claim 15, wherein the distance from the first side to the first prefold line is almost equal to the distance from the first prefold line to the tab prefold line.

17. A mailer as in claim 15, wherein the point of the triangle opposite the first side can be inserted into the slot when the mailer is folded along the first prefold line and the tab prefold line.

18. A mailer as in claim 15, wherein the mailer further comprises a second prefold line approximately perpendicular to the first side and situated at a distance from the midpoint of the first side.

19. A mailer as in claim 18, wherein the mailer further comprises a third prefold line approximately perpendicular to the first side and situated at a distance from the midpoint of the first side, wherein the second and third prefold lines are on opposite sides of the midpoint of the first side.

20. A mailer as in claim 24 comprising a single sheet of printable material having a generally rectangular shape plus a tab feature extending from a first edge of the rectangle along not more than one half of the first edge;
a. wherein the sheet has a first prefold line substantially parallel to and equidistant from the first edge;
b. wherein the sheet has a second prefold line substantially perpendicular to the first edge and intersecting the first edge at about the midpoint of the first edge; and
c. wherein the sheet has first and second slots in the sheet near the an edge that, when the mailer is folded along the first and second prefold lines, will be near and on the opposite side of from the first edge, wherein the slots are configured to accept at least a portion of the tab feature.

21. A mailer as in claim 20, wherein the tab feature comprises an extension of the sheet having a portion of the edges perpendicular to the first edge relieved such that the remaining corners can be inserted into the first and second slots.

22. A mailer as in claim 20, wherein the tab feature comprises a convex shape cut into a portion of the sheet extending beyond the first edge such that the convex features can be separated from the plane of the portion and inserted into the first and second slots.

23. A mailer as in claim 22, wherein the convex features are semicircular, wedge-shaped, rectangular, rectangular with rounded corners, pentagonal, elliptical, or a combination thereof.

24. A mailer comprising a sheet on which one or more images can be placed, comprising a plurality of prefold lines and at least one resealable attachment feature such that the mailer can be folded and the attachment feature engaged to maintain the folded mailer in a folded state.
